(19) United States
(12) Patent Application Publication
(10) Pub. No.: US 2016/0325369 A1
(43) Pub. Date: Nov. 10, 2016

(54) BRAZE CLADDING

(71) Applicant: Delavan Inc, West Des Moines, IA (US)

(72) Inventors: Lev A. Prociw, Johnston, IA (US); Jason A. Ryon, Carlisle, IA (US); Steven J. Myers, Norwalk, IA (US); Michael J. Bronson, West Des Moines, IA (US)

(73) Assignee: DELAVAN INC, West Des Moines, IA (US)

(21) Appl. No.: 14/704,550

(22) Filed: May 5, 2015

(51) Int. Cl. B23K 1/20; B32B 15/01; B23K 1/00; B23K 35/30; B23K 31/02; B23K 35/02

(52) U.S. Cl. CPC B23K 1/20; B23K 31/02; B23K 35/0244; B23K 1/0012; B23K 35/3033; B23K 35/3053; B32B 15/01

(57) ABSTRACT

A method of manufacturing includes depositing a predetermined amount of braze material directly to a joint location of a first component and joining the first component to a second component at the braze joint location. The method also optionally includes depositing a predetermined amount of braze material directly to a joint location of the second component. Machining down the braze material on each of the first and second components can be used to provide a preformed braze joint.

### BACKGROUND OF THE INVENTION

1. Field of the Invention

The present disclosure relates to manufacturing and, more particularly, to brazing components during manufacturing.

2. Description of Related Art

Conventional construction of components which undergo high heat during operation, such as fuel injectors, nozzles, atomizers and heat exchangers, include the components bonded together by braze. The components are typically nested within one another or stacked and form a narrow gap which is filled with a braze alloy. Typically, the braze alloy is applied as a braze paste, wire ring, or as a thin sheet shim on the external surfaces or within pockets inside the assembly. Applying braze paste is a very manual process and often can be inconsistent. Braze rings are an improvement but still must be manually positioned and are sensitive to placement. Braze plating requires masking. All of these challenges can lead to high scrap rates. Too little braze creates holes and leakage in the assembly and too much braze results in excess material, e.g., that can block intended fuel or air passages in atomizers and the like. There is a need in the art to more accurately apply a specific amount of braze material to the correct locations. The present disclosure provides a solution for this need.

### SUMMARY OF THE INVENTION

A method of manufacturing includes depositing a predetermined amount of braze material directly to a joint location of a first component and joining the first component to a second component at the braze joint location. The method also optionally includes depositing a predetermined amount of braze material directly to a joint location of the second component. Machining down the braze material on each of the first and second components can be used to provide a preformed braze joint.

The method can include depositing the braze material to each of the first and second components as a powder and sintering this powder to the surface through the use of a laser. The method can include depositing the braze material to each of the first and second components as a cold spray. It is also contemplated that the method can include depositing the braze material to each of the first and second components as a melted braze filament.

It is possible for the braze material to only be deposited on a portion of the first component to be joined with the second component. It is also possible for the braze material to only be deposited on a portion of the second component to be joined with the first component.

The braze material can include at least one material chosen from the group consisting of bronze-based matrix materials containing nickel, steel-based matrix materials containing nickel, and steel alloys containing chromium, nickel, molybdenum, silicon, vanadium, carbon, gold, silver and/or copper, as required.

The method can include heating the first and second components to melt the braze materials and form a braze joint. During heating of the braze material, the braze material can congeal on the respective first and second component portions.

A first component and a second component can be joined by the processes described above.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a cross-sectional side elevation view of an embodiment of a braze ring of the prior art;

FIG. 2 is a cross-sectional side elevation view of an embodiment of a braze material applied in the prior art;

FIG. 3 is a cross-sectional side elevation view of an exemplary embodiment of a brazed assembly constructed in accordance with the present disclosure, showing a predetermined braze amount deposited on a first component;

FIG. 4 is a detailed view of the braze of FIG. 1;

FIG. 5 is a cross-sectional side elevation view of another exemplary embodiment of a first component, showing a predetermined amount of braze applied to the first component;

FIG. 6 is a perspective view of a single layer of a component, showing braze material added to the periphery of the component;

FIG. 7 is a perspective view of a stacked assembly formed from multiple layers of the brazed component of FIG. 6; and

FIG. 8 is a perspective view of a multiple layers of an assembly of FIG. 7, showing a duct formed within the multiple layers.

### DETAILED DESCRIPTION OF THE PREFERRED EMBODIMENTS

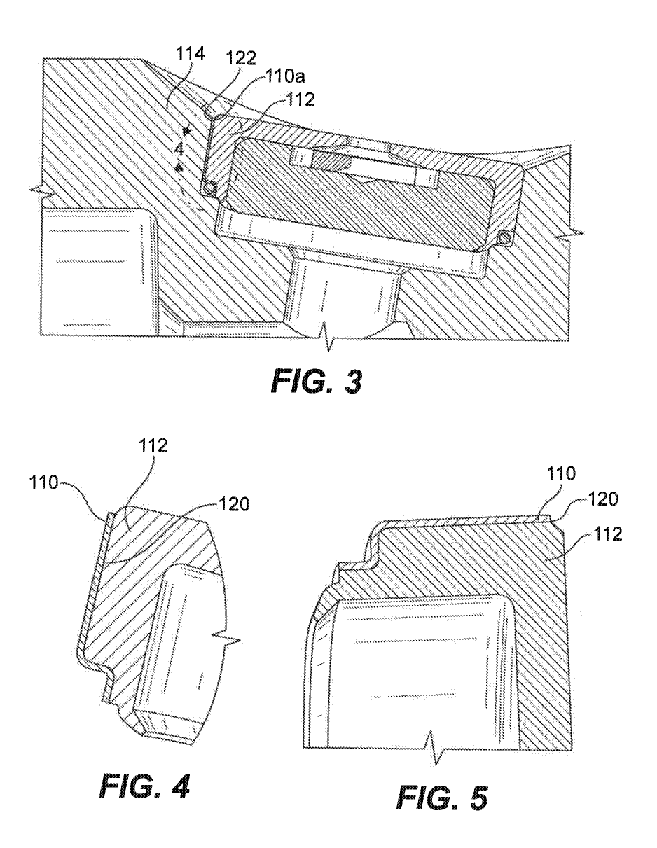

Reference will now be made to the drawings wherein like reference numerals identify similar structural features or aspects of the subject disclosure. For purposes of explanation and illustration, and not limitation, a partial view of an exemplary embodiment of a method for manufacturing in accordance with the disclosure is shown in FIG. 3 and is designated generally by reference character 100. Other embodiments of methods of manufacturing in accordance with the disclosure, or aspects thereof, are provided in FIGS. 4-8, as will be described.

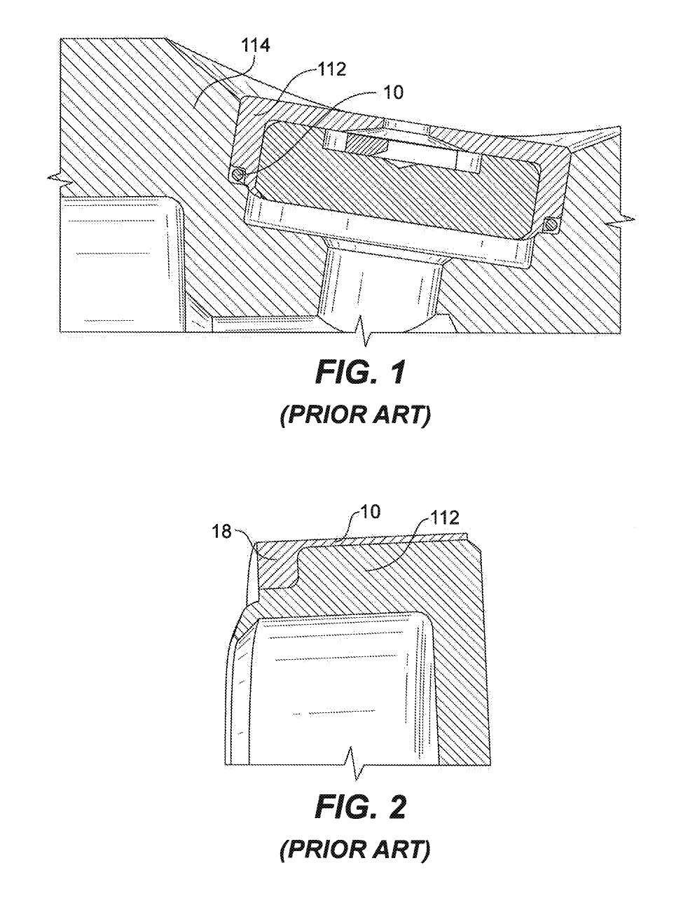

FIGS. 1 and 2 illustrate the typical methods of applying a braze to create a braze joint between two components 112, 114 of an assembly. In FIG. 1 a braze ring 10 is manually positioned and in FIG. 2 a braze paste 16 is shown with excess braze material 18 not ultimately part of the braze joint.

With reference to FIGS. 3 and 4 the method of manufacturing of the present disclosure is shown in contrast to the prior art method shown in FIG. 1. The components 112, 114 can be, for example, parts of a fuel nozzle or fuel injector assembly. A predetermined amount of braze material 110 is directly applied to a joint location 110a. More specifically, a predetermined amount of braze material 110 is applied to a surface 120 of the first component 112 that engages with the second component 114. A predetermined about of braze 110 can also optionally be applied to the second component 114 at a surface 122 that engages with the first component 112 to further strengthen the bond between the first and second components. The first and second components 112, 114 are joined at the joint location 110a by heating the braze material 110 to form the joint location 110a. The braze material 110 can include at least one material including bronze-based matrix materials containing nickel, steel-based matrix materials containing nickel, and steel alloys containing chromium, nickel, molybdenum, silicon, vanadium, carbon, gold, silver and/or copper as well as other alloys could be used)

The braze material 110 is applied to the first component 112 and/or the second component 114 using laser cladding. Laser cladding is a process in which an alloy of cladding material (in the form of a wire, powder, etc.) is applied to a surface to permit accurate, consistent application of material. A concentrated laser beam moves relative to the surface to melt the applied alloy and a thin layer of the surface material to form a cladding that is metallurgically bonded. Laser cladding is similar to thermal spraying in that an energy source is used to melt the alloy that is being applied to a substrate. However, unlike thermal spraying, laser cladding also melts a thin layer of the substrate that the alloy is being applied to. This melting results in a fused metal and strong metallurgical bond between the cladding and the surface the alloy is applied to. Typically, laser cladding results in an interface with a superior bond strength over thermal spraying. Since a concentrated laser beam is used as the heat source, the heat affected zone will be minimal. Any suitable known laser cladding process may be used to deposit the braze material to the joint location.

Referring to FIG. 5 the method of manufacturing is shown in contrast to the prior art method of FIG. 2. As illustrated, using laser cladding to apply a predetermined amount of braze material 110 is applied to the first component 112 which reduces or eliminates extra braze material that results from typical braze applications. As shown in FIG. 5, the braze material 110 is applied as a thin, even layer directly on the surface 120 of the first component 112. The braze material 110 is only applied to the surface 120 that is to be joined with the second component 114, i.e., the braze joint 110a. The method of laser cladding allows the braze material 110 to be selectively applied following the exact curvature, shape, and lines of the first and second components. If needed, the braze material 110 can be machined down after laser cladding to further even out the layer of the braze material 110 and create preformed braze joints 110a.

In certain embodiments, the distribution of braze material can also be accomplished using the ‘cold spray’ process which is an additive material process using high velocity gas to deliver an impinging stream of metal powder and gas to the substrate surface. The powder sticks to the surface due to the force of the impact of the powder onto the surface.

In another embodiment, a wire made of suitable braze material is unwound with an end of the wire in close proximity to the surface of the component part where the braze joint is intended to be formed. A laser or other heat source is applied to the filament (i.e. end of the wire) such that the braze material is melted and applied to the surface.

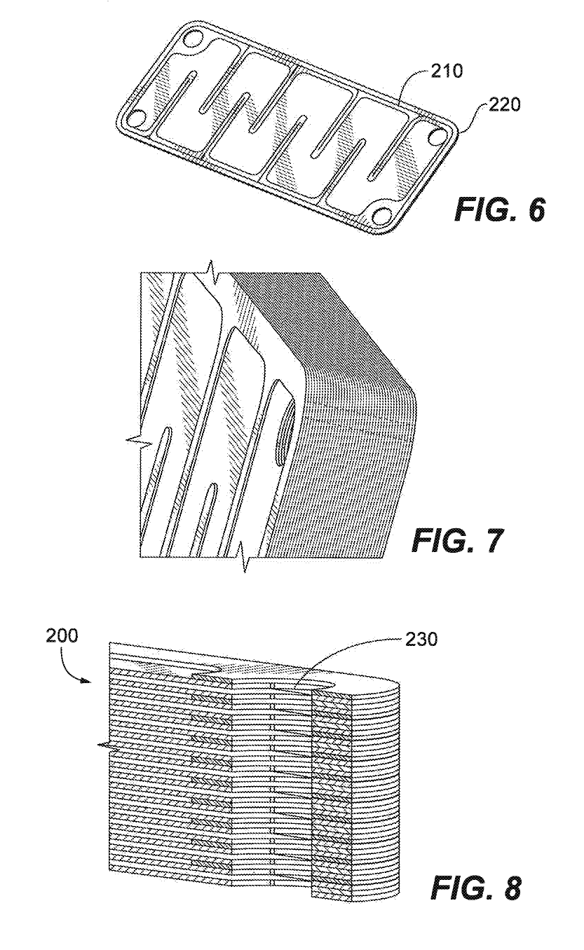

With reference to FIGS. 6-8 an example of applying the predetermined braze material 210 is shown for a plate heat exchanger 200 having a plurality of stacked layers. Applying the braze material using laser cladding allows the braze 210 to be applied to a larger surfaces and not just in between small spaces of an assembly. The layer 220 shown in FIG. 6 illustrates an example of a spacer plate with flow features and a foil to which the spacer is brazed wherein fluid flows between diagonal corners resulting in a high efficiency counter flow heat exchange with the lowest possible stresses. Flipping the spacer plate orientation in alternate layers controls whether the layer is for hot or cold flow. Heat exchangers can be used in refrigeration, air conditioning, internal combustion engines, or the like. As shown in FIG. 6, the braze material 210 is applied to a periphery of each layer of spacer plates 220 of the heat exchanger. In the same manner as described above, the braze material 210 is applied in a thin, uniform layer prior to stacking. As shown in FIG. 7, multiple layers are stacked and brazed together to form the structure 200. Braze 210 can also be applied to the surface of the structure 200, if needed, to act as a filler for any edge gaps that may form between the plates 220. As shown in FIG. 8, header ducts 230, for example, to bring cold and hot fluids into and out of the heat exchanger, can be formed implicitly within the stacked layers during manufacturing.

The methods and systems of the present disclosure, as described above and shown in the drawings, provide for a method of manufacturing with superior properties including improved precision in brazing. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A method of manufacturing, comprising:
depositing a predetermined amount of braze material directly to a joint location of a first component; and
joining the first component to a second component at the braze joint location.

2. The method of claim 1, further comprising depositing a predetermined amount of braze material directly to a joint location of the second component.

3. The method of claim 1, further comprising machining down the braze material on each of the first and second components to provide a preformed braze layer.

4. The method of claim 1, further comprising depositing the braze material to each of the first and second components as a powder and sintering the powder to the surface through the use of a laser.

5. The method of claim 1, further comprising depositing the braze material to each of the first and second components using cold spray process.

6. The method of claim 1, further comprising depositing the braze material to each of the first and second components as a melted brazed filament.

7. The method of claim 1, wherein the braze material is only deposited on a portion of the first component to be joined with the second component, wherein the braze material is only deposited on a portion of the second component to be joined with the first component.

8. The method of claim 1 wherein the braze material includes at least one material chosen from the group consisting of bronze-based matrix materials containing nickel, steel-based matrix materials containing nickel, and steel alloys containing chromium, nickel, molybdenum, silicon, vanadium, carbon and alloys of gold, silver, and/or copper).

9. The method of claim 1, further comprising heating the first and second components to melt the braze materials and form a braze joint.

10. The method of claim 1, wherein during heating the braze material, the braze material congeals on the respective first and second component portions.

11. The method of claim 1, further comprising repeating the steps of depositing and joining to form braze joints between multiple layers of components to form a structure.

12. The method of claim 11, wherein the first and second components are spacer plates for a heat exchanger such that the braze material is deposited on a periphery of the spacer plates.

13. A process of joining a first and second component by depositing a predetermined amount of braze material directly to a braze joint location of the first component and joining the first component to the second component at the braze joint location.

14. A first component and a second component manufactured by the process of claim 11.
